(19) United States
(12) Patent Application Publication
(10) Pub. No.: US 2021/0209509 A1
(43) Pub. Date: Jul. 8, 2021

(54) SYSTEM AND METHOD FOR GUIDED SYNTHESIS OF TRAINING DATA

(71) Applicant: Alegion, Inc., Austin, TX (US)

(72) Inventor: Cheryl Elizabeth Martin, Austin, TX (US)

(21) Appl. No.: 17/143,403

(22) Filed: Jan. 7, 2021

Related U.S. Application Data
(60) Provisional application No. 62/958,100, filed on Jan. 7, 2020.

(51) Int. Cl. G06N 20/00; G06F 16/25

(52) U.S. Cl. CPC G06N 20/00; G06F 16/258

(57) ABSTRACT

Embodiments described herein provide mechanisms to generate synthetic data that meets customized invariance and diversity criteria at scale using a combination of machine and human activities. Embodiments can be used, for example, to generate a large set of labeled data that preserves invariances that are relevant to a specified target application (e.g., training a ML model to produce a given inference) while expanding both the quantity and diversity/variation of data relevant to that application. In some embodiments, a complex workflow can be defined that combines stages having both machine processes and human processes that provide guidance from assessors to generators such that subsequent data generation is improved through feedback that can include human input at scale.

### RELATED APPLICATIONS

This application claims the benefit of priority under 35 U.S.C. § 119(e) to U.S. Provisional Patent Application No. 62/958,100 filed Jan. 7, 2020, entitled “System and Method for Guided Synthesis of Training Data,” which is hereby fully incorporated by reference herein for all purposes.

### TECHNICAL FIELD

Embodiments relate to computer systems and computer implemented methods relating to machine learning techniques. More particularly, embodiments relate to systems and methods for guided synthesis of training data for use with machine learning systems.

### BACKGROUND

Machine learning (ML) techniques enable a machine to learn to automatically and accurately make estimates or predictions based on historical observation. Training an ML algorithm involves feeding the ML algorithm with training data to build an ML model. The accuracy of a ML model depends on the quantity and quality of the training data used to build the ML model. It is, however, often time consuming, expensive, and in some cases impossible, to collect enough real-world training data to accurately train ML models.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagrammatic representation of one embodiment of an environment for generating synthetic data;

FIG. 2 is a diagrammatic representation of one embodiment of a process;

FIG. 3 is a diagrammatic representation of a detailed view for one embodiment of processing by a human process;

FIG. 4 illustrates one example of guided data synthesis using generator/assessor feedback;

FIG. 5 illustrates another example of guided data synthesis using generator/assessor feedback;

FIG. 6 is a diagrammatic representation of one embodiment of guided data synthesis using customized transforms feedback;

FIG. 7 is a diagrammatic representation of one embodiment of processing source data to generate a set of training data.

### SUMMARY

Embodiments described herein provide mechanisms to generate synthetic data that meets customized invariance and diversity criteria at scale using a combination of machine and human activities. Embodiments can be used, for example, to generate a large set of labeled data that preserves invariances that are relevant to a specified target application (e.g., training a ML model to produce a given inference) while expanding both the quantity and diversity/variation of data relevant to that application. In some embodiments, a complex workflow can be defined that combines stages having both machine processes and human processes that provide guidance from assessors to generators such that subsequent data generation is improved through feedback that can include human input at scale.

One embodiment comprises a computer-implemented method for guided synthesis of training data, including receiving a set of input data from a data store, the input data comprising training data for a machine learning process. The method transforms the set of input data, by a generator process, to generate a set of output data. An assessor process provides an assessment of the set of output data against a set of characteristics to determine whether the set of characteristics are met by the set of output data. In some embodiments, the assessor processor is a human process that supports the interaction with a human specialist. The output data can be augmented by the generator process, based on the assessment provided by the assessor process to generate a set of synthetic training data.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of systems and methods for guided synthesis of data are provided herein. Synthesis, in this context, refers to generating synthetic data. Synthetic data is data that is artificially manufactured rather than generated by real world events. Such data can be used for a variety of purposes. For example, synthetic data can be used to “fill out the space” of examples that an ML model is trained on to include otherwise unavailable datapoints, allowing the ML model to better identify the separation (boundaries) between categories/classes. The use of synthetic data is particularly beneficial when a sufficient number of real-world data examples are too difficult or expensive to collect or are unavailable at all.

Although there are well-understood and generally applicable content-preserving transformations for some types of data and applications (consider image transformations that preserve content, such as rotation) that can be implemented by machines to generate data, there are often application-specific constraints and variations desired, which cannot be universally encoded to increase the size and diversity of labeled data. Embodiments described herein provide mechanisms to generate new labeled data that meets customized invariance and diversity criteria at scale using a combination of machine and human activities. Embodiments can be used, for example, to generate a large set of labeled data that preserves invariances that are relevant to a specified target application (e.g., training a ML model to produce a given inference) while expanding both the quantity and diversity/variation of data relevant to that application.

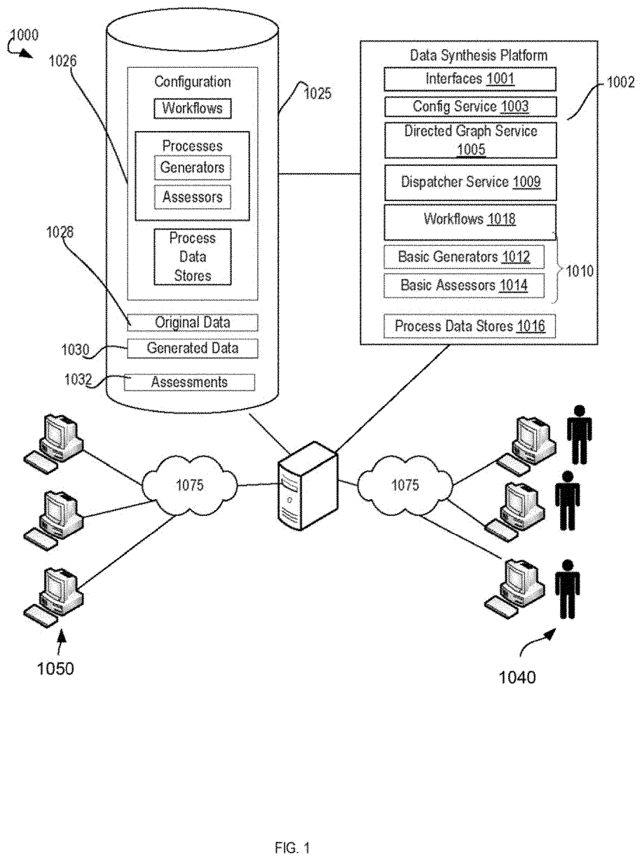

FIG. 1 is a diagrammatic representation of one embodiment of an environment 1000 for generating synthetic data. In the illustrated embodiment, environment 1000 comprises a data synthesis platform coupled through network 1075 to various computing devices. Network 1075 comprises, for example, a wireless or wireline communication network, the Internet or wide area network (WAN), a local area network (LAN), or any other type of communications link. In some embodiments, data synthesis platform 1002 is implemented as part of a labeling platform that applies ML and/or human labelers to label data. By way of example, but not limitation, data synthesis platform 1002 may be implemented as part of a labeling platform as described in U.S. Provisional Patent Application No. 62/884,512, entitled “Confidence Driven Workflow Orchestrator,” filed Aug. 8, 2019, or U.S. Provisional Patent Application No. 62/950,699, entitled “Labeling Platform,” filed Dec. 19, 2019, both of which are incorporated by reference herein. Thus, platform 1002 may comprise a software system for data annotation, transformation, generation, validation, verification, and valuation.

Data synthesis platform 1002 executes on a computer—for example one or more servers—with one or more processors executing instructions embodied on one or more computer readable media where the instructions are configured to perform at least some of the functionality associated with embodiments of the present invention. These applications may include one or more applications (instructions embodied on a computer readable media) configured to implement one or more interfaces 1001 utilized by data synthesis platform 1002 to gather data from or provide data to computer systems 1040, client computer systems 1050, or other computer systems. It will be understood that the particular interface 1001 utilized in a given context may depend on the functionality being implemented by data synthesis platform 1002, the type of network 1075 utilized to communicate with any particular entity, the type of data to be obtained or presented, the time interval at which data is obtained from the entities, the types of systems utilized at the various entities, etc. Thus, these interfaces may include, for example web pages, web services, a data entry or database application to which data can be entered or otherwise accessed by an operator, APIs, libraries or other type of interface which it is desired to be utilized in a particular context.

In the embodiment illustrated, data synthesis platform 1002 comprises a number of services including a configuration service 1003, directed graph service 1005 and dispatcher service 1009. Data synthesis platform 1002 can be configured to implement a wide variety of workflows 1018 to generate synthetic data. At a high level, data synthesis platform 1002 includes a number of configurable basic processes 1010 that can be composed into workflows 1018. More particularly, platform 1002 includes workflow configuration capabilities to allow end-users to combine basic processes into complex processes and combine processes into workflows 1018. Each workflow 1018 is a configured set of one or more processes (basic or complex) that execute within the platform 1002 to achieve a desired goal (e.g., labeled data generation). During execution of a process within platform 1002, dispatcher service 1009 may distribute tasks to human users at computer systems 1040 to allow human users to perform one or more operations associated with the process.

Platform 1002 includes a configuration service 1003 that allows end-users (a “configurer”) at client computer system 1050 to create configurations for workflows and data synthesis platform 1002 utilizes a data store (DS) 1025 operable to store configuration data 1026. Data store 1025 may comprise one or more databases, file systems, combinations thereof or other data stores. Configuration data 1026, which may include a wide variety of configuration data, including but not limited to configuration data for configuring directed graph service 1005, workflows 1018, processes 1010 and other aspects of data synthesis platform 1002.

In the illustrated embodiment, data synthesis platform 1002 also stores initial or original data 1028, generated or synthetic data 1030 and assessments 1032. Original data 1028 may include a set of labeled data. Labeled data may be labeled with a number (e.g., a value output based on a regression model) a class label, a bounding box around an object in an image, a string of words that characterize/describe the input (e.g., “alt text” for images), an identification of segmentation (e.g., “chunking” a sentence into subject and predicate). Labels for original data may be generated by the labeling platform or provided by an external source. Synthetic data 1030 includes synthetic data generated by the generators of the data synthesis platform 1002. In some embodiments, one or more generators generate synthetic data by processing original data 1028.

According to one embodiment, a user can configure a workflow by specifying, for example, the stages of the workflow (e.g., which processes 1010 to execute, configuration parameters for the processes, which process data stores 1016 to use (if logically distinct from the processes) the connections between the inputs and outputs of the processes and data stores, conditional logic etc.). In some embodiments, configuration data 1026 can specify, for a workflow, input and output of each stage, stage guards, furcation, and other aspects of a processing graph to implement a workflow. Platform 1002 supports configurations that combine both human and automated stages into workflows with complex data flow paths, including iteration/loops, conditional branching, and fan-out/fan-in.

Directed graph service 1005 uses the configuration information 1026 for a workflow 1018 to implement the workflow according to a directed graph, where each node in the graph represents either a process or a process data store and each edge in the graph represents data flow in the specified direction.

One of the basic building blocks of the directed graph implemented by directed graph service 1005 are processes. A process is a node that takes one or more pieces of input data, performs operation(s) and produces one or more pieces of output data. Processes can be hierarchically specified and implemented. A process may itself represent a subgraph of other processes and data stores with internal data flows.

According to one embodiment, platform 1002 includes machine process (MPs) and human process (HPs). Note that the term “human process” refers to computer code relating to a process that can involve a human in some manner, such as providing an interface for requesting and accepting input from a human, advanced tooling or automation to support human interactions, etc. “Human process” is not merely a step or tasked performed by a human, and in fact, likely could not be performed entirely by a human. MPs are fully executed by computers and do not require human or manual operations to produce output data from one or more pieces of input data. HPs, on the other hand, require human or manual operations. In some examples, processes are considered Human if they involve a human at all when performing operations to produce one or more pieces of output data from the one or more pieces of input data. It can be noted HPs encompass computer-based components (e.g., ranging from a user interface to provide information to a human and accept input from a human to advanced tooling or automation to support human interactions). As discussed below, each process has an associated environment that is instantiated by platform 1002.

According to one embodiment, each process has a specified API (application programming interface). Processes interact with data stores as needed (customized by the individual implementations of the processes and instantiations of their respective environments). A process's behavior may be statically or dynamically defined as long as it satisfies the API constraints of the process. Platform 1002 provides provenance tracking and configuration tracking for auditing workflow stages and therefore for the source of any resulting data or assessments in process data store (e.g., the version of process, the process's configuration and/or component versions, timestamps for instantiation and executions, etc.).

More particularly, a data synthesis platform includes logic to instantiate basic processes 1010 that can be configured and executed as needed. Basic processes 1010 can be combined to form more complex processes using the platform's workflow configuration capabilities to combine multiple stages. Processes can be defined hierarchically by configuring one process to interact with another, separately defined, workflow, which may itself contain complex processes defined using multiple stages and various data flow control options. Basic processes 1010 can include a wide variety of processes including, but not limited to basic generators 1012 and basic assessors 1014.

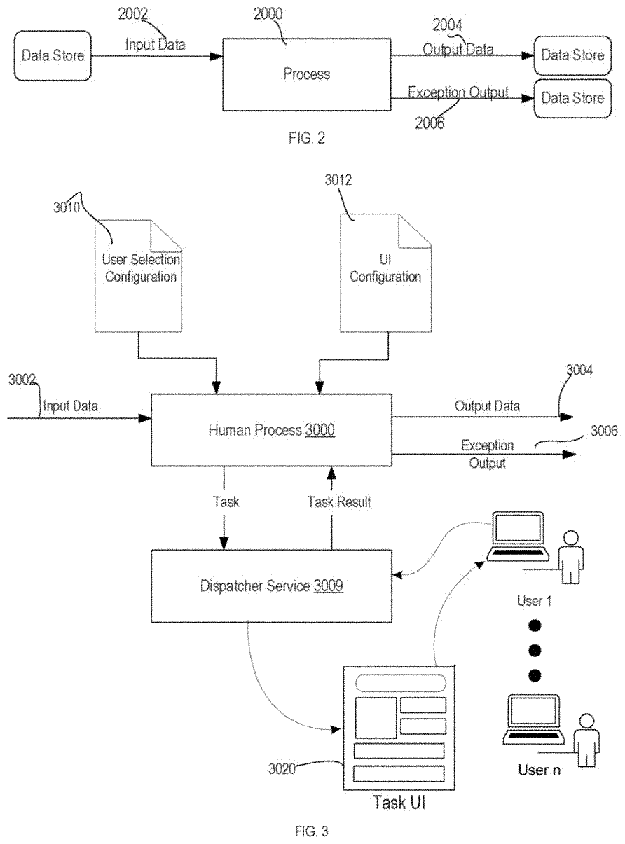

Turning briefly to FIG. 2, a high-level block diagram of one embodiment of a process 2000 is provided. Process 2000 receives input data 2000, performs one or more operations based on the input data and generates output data 2004. A process 2000 can also output exceptions 2006. According to one embodiment, input data 2002 is received from a first process data store. The first, second and third process data stores may be the same data store or different data stores depending on configuration. In some embodiments, the first, second and third data stores are in the memory space of process 2000 or another process in the workflow. Process 2000 can represent a basic process 1010 or a complex process that is a combination of sub-processes, which may themselves be basic or complex processes, and process data stores with internal data flows. Process 2000 is considered an MP if all the operations between the input data 2002 and output data 2004 are computer implemented. Process 2000 is considered an HP if a human performs operations on data between input data 2002 and output data 2004.

FIG. 3 illustrates one embodiment of processing by a human process 3000. In the illustrated embodiment, human process 3000 receives input data 3002 on which human process 3000 is configured to perform an operation (e.g., generate new data points from existing data points, assess a data point generated by a generator process, or perform another operation) and outputs result 3004 (e.g., transformed input data, an assessment or other output data, depending on the human process 3000). Human process 3000 may also output exceptions 3006.

Human process 3000 can be configured according to user selection configuration 3010 (e.g., workforce selection criteria) and a task user interface (UI) configuration 3012. User selection configuration 3010 provides criteria for selecting human specialists to which a task can be routed. User selection configuration 3010 can include, for example, platform requirements, workforce requirements and individual specialist requirements. In some embodiments, platform 1002 can send tasks to human specialists over various platforms (e.g., Amazon Mechanical Turk marketplace and other platforms). User selection configuration 3010 can thus specify the platform(s) over which tasks for the process can be routed. Human specialist platforms may have designated workforces (defined groups of human specialists). User selection configuration 3010 can specify the defined groups of human specialists to which tasks from the process can be routed. If a workforce is declared in configuration 3010, a human specialist must be a member of that workforce for tasks for the process 3000 to be routed to that human specialist. User selection configuration 3010 may also specify criteria for the individual specialists to be routed a task for process 3000.

Task UI configuration 3012 specifies a task UI to use for an operation and the options available in the UI. According to one embodiment, a number of task templates can be defined for human specialists with each task template expressing a user interface to use for presenting data points and receiving new data or assessments. Task UI configuration 3012 can specify which template to use and the options to be made available in the task UI.

When human process 3000 ingests input data or receives a request to perform an operation, process 3000 packages the input data and/or request with the user selection configuration 3010 and task UI template configuration 3012 as a task and sends the task to dispatcher service 3009 (e.g., dispatcher service 3009). Dispatcher service 3009 is a highly scalable long-lived service responsible for accepting tasks from many different processes and routing them to the appropriate endpoint for human specialist access to the task. Once a specialist (User 1) accepts a task from the dispatcher service 3009, the platform (e.g., the dispatcher service 3009) serves the configured browser-based task UI 3020 to the worker, then accepts a task result from the specialist (User 1) and validates it before sending the task result back to process 3000.

Returning to FIG. 1, data synthesis platform 1002 further implements process data stores 1016. A process data store 1016 represents a repository from which data and sets of data can be accessed and into which data and sets of data can be placed. Process data stores 1016 can be hierarchically specified and implemented. A process data store 1016 may represent a (subgraph of) other processes (e.g., transforms, translations, etc.) and process data stores (e.g., distributed stores) with internal data flows. While process data stores 1016 are generally described as being logically separate from the processes for the purposes of the descriptions herein, in some implementations, a process data store but may be implemented with in-process memory (for MPs) or otherwise inseparable from the processes.

A data flow is the paradigm by which data flows into and out of a process or process data store. A data flow can include any suitable method for flowing data into and out of a process or data store or output data from a process or data store (e.g., database read/write, publish/subscribe, produced/consumer).

A generator is a process that creates one or more new pieces of data (data instances) of a particular form (e.g., an image, a piece of text) with the goal that the data's characteristics conform to a set of pre-specified constraints. The form of the output data may be validated within the generator component against a specified data format standard (e.g., is it a valid image format, is it a valid set of text strings?). Beyond the validity of the data format, the desired data characteristics are pre-specified in a format that can be validated outside the generator by an assessor. A generator can run open-loop, without accepting any information about how well (or if) previously generated data conforms to the desired data characteristics. However, typically, a generator will use assessments of previously generated data to guide and improve the generation of future data. The previously generated data for which such assessments are provided to the generator may come from the generator itself (i.e., feedback) or any other source. Such assessments are provided by an assessor. Multiple generators may be employed for any given workflow, and the generators in a workflow may operate in parallel.

The API of a generator specifies a trigger or potential triggers to which the generator responds for executing data generation and the format of the data points the generator produces, including any annotations with which the generator augments the data points.

According to one embodiment, platform 1002 supports defining and using basic generator processes 1012 as single stages. Non-limiting examples of basic generators are described below. One example of a generator is a human process (HP) that includes a pre-specified set of instructions that one or more humans have been trained to follow to provide a new data point (e.g., “take a picture of a cat and upload it”). Note that the HP can encapsulate the interfaces to provide instructions to and receive the data point from the human. Another example of a generator is an HP that includes a pre-specified set of instructions that one or more humans have been trained to follow to transform a provided data point into a new data point (e.g., “Record your voice speaking the provided text”). Again, the HP can encapsulate the interfaces to provide instructions to and receive the data point from the human. Another example of a generator is a machine process (MP) that transforms a provided data point into a new data point or points (e.g., an image transformation that flips, rotates or crops images, inserts variances into an image or performs other transformations on images or other data points). Another example of a generator is an MP that has a pre-specified set of programmatic rules (code) it uses to generate a data point (e.g., a simulation executed under some set of configuration or initialization conditions). Another example of a generator is an MP that uses a Machine Learning model that has been trained to provide the desired type of data point (e.g., an ML model produces images of faces of people that don't really exist). Complex generators can be created using workflow stage combinations.

An assessor is a process that reviews data against a set of pre-specified (desired) characteristics, determines if the characteristics are sufficiently met (where “sufficient” is also custom-defined, e.g., by relevant thresholds), and produces an assessment of the data (“feedback” for generated data) against the desired characteristics. The format of this assessment may vary. Some options include a binary good/bad assessment, a quantitative value indicating the degree to which the characteristics are met, a set/vector of values (binary or continuous) indicating the degree to which individual characteristics are met, or a free-form expression (such as prose/text) of quality along one or more dimensions. The possible formats and content of valuations/assessments produced by an assessor are not limited by the capabilities of generators at any given point in time to use the assessments as feedback—that is, an assessor may produce feedback that only a yet-to-be-developed generator could interpret and consume. Multiple assessors may be employed for any given workflow. In some embodiments, assessors in a workflow operate in parallel, and each piece of generated data may be assessed by one, some, or all assessors in a workflow.

The API of an assessor specifies the format of the data points the assessor can evaluate, an optional set of annotations (labels) with which the data points can be augmented that the Assessor can evaluate, the syntactic format of the assessment output (e.g., a single value or a set of values), some description of the output's semantic meaning (e.g., higher values in output position 1 mean the data point is more realistic, higher values in output position 2 mean the data point is more unusual, etc.), and an optional overall description of what the assessor is assessing (purpose).

According to one embodiment, the platform 1002 supports defining and using basic assessor processes 1014 as single stages. Some examples of basic assessor processes include, but are not limited to, the following examples. One example is an HP that has a pre-specified set of instructions that one or more humans have been trained to follow to provide an assessment (e.g., “Does image contain a realistic face?”). The HP can encapsulate the interfaces to provide instructions to and receive the data point from the human. Another example of an assessor is an MP that has a pre-specified set of programmatic rules (code) it uses to generate an assessment (e.g., a spelling or grammar checker for text). Another example of an assessor is an MP that uses a Machine Learning model that has been trained to provide the desired assessment (e.g., an ML model that rates image quality). Complex assessors can be created using workflow stage combinations.

Each generator operates within a configured generator environment that logically groups generator processes and data stores for a given workflow, allowing generators to access previously generated data (including data generated through other means besides, e.g., an original data set) as well as any assessments of that data.

Each assessor operates within a configured assessor environment that logically groups assessor processes and data stores for a given workflow allowing such that relevant input sources and output destinations for data are available to the assessor processes. It can be noted that the generator and assessor environments can share datastores (e.g., one or more process data stores 1016).

As discussed above, a workflow 1018 is a configured set of one or more processes that execute within the platform 1002 to achieve a desired goal. Workflows can be represented as directed graphs where data flow through processes and process data stores may be either described based on shared resources or temporally. For example, a basic generator workflow can be represented as:

DS-><-Generator|-logically same as-|DS->Generator->DS

Descriptions of workflows below are based on temporal snapshots of a processing graph for clarity. It should be noted, however, that while process data stores are depicted as separate instances in the following descriptions to describe different data content at different points in time, process data stores can use either the same computational resources or be synched/bulk transferred in standard ways.

Moving data between processes and process data stores may use any standard data transfer methods (pull or push, batch or query, publish/subscribe, streaming, synchronization, etc.).

The following example provides one embodiment of a workflow for a basic generator processor (e.g., a workflow for a basic generator 1012). In this example, the workflow includes the following: a data store, which stores pre-existing data, if any, to be used by the generator, with or without assessments. Any data point that does not have an assessment can be optionally be routed through an assessor workflow to augment it with assessments, or data points may be marked as original or externally generated and treated by generators as a special case; a generator (creates new data points). The generator may use any or all existing data with or without assessment information (based on the generator's individual capabilities to process and interpret the data and data volume; and a data store (stores data points generated by the generator).

The following example provides one embodiment of a workflow for a basic assessor 1014. In this example, the workflow includes: a data store (holds data points to assess, points that need assessments); an assessor (provides an assessment/valuation of each data point); and a data store (stores assessments for each data point along with the data point itself or a reference to the data point).

Generators and assessors can be combined in a workflow. The following provides one example of a workflow for a combined basic generator/basic assessor combination. In this example, the workflow includes: a data store (pre-existing data, if any, with or without assessments); a generator (creates new data points); a data store (stores data points generated by the generator); an assessor (provides an assessment/valuation of each data point); and a data store (stores assessments for each data point along with the data point. The combined basic generator/assessor workflow can be expressed as:

DS->G->DS

|<-A<-|

A generator or assessor process can be configured as one or more stages in a workflow in the platform 1002 (e.g., according to a configuration 1026). According to one embodiment, platform 1002 provides the mechanism to define custom configuration information for any stage and pass that configuration information to the software components (e.g., the processes) implementing that stage. If the stage requires human input (e.g., if the stage includes an HP), then the components implementing that stage provide the user interface and access to required input mechanisms. The same workflow may contain both generator and assessor processes as different stages using any platform workflow configuration options (stages in sequence, parallel, or iterative flow, using fan-in and fan-out, etc.). As discussed above, each process has an associated environment that is instantiated by platform 1002.

Basic processes can be combined to form more complex processes using the platform's workflow configuration capabilities to combine multiple stages. For example, more complex generators and more complex assessors can be created using workflow stage combinations. Basic generators, complex generators, basic assessors and/or complex assessors can be combined.

Data synthesis platform 1002 supports configuring workflows to achieve a wide variety of synthetic data generators. For example, a generator and assessor can be combined to create a generative adversarial network (GAN) or other complex processes.

According to one embodiment, configuration 1026 can define a complex workflow that combines stages having both MPs and HPs to, for example, provide guidance from assessors to generators such that subsequent data generation is improved through feedback that can include human input at scale.

According to one embodiment, the basic generator examples provided above could all be implemented in an open-loop fashion, where the generator process is activated, provides some amount of new data points, and does not refer to assessments of its generated data to improve subsequent data generation. However, in some implementations, generators can implement various reinforcement learning algorithms known or developed in the art and can therefore accept feedback. Platform 1002 supports human-generated assessments of each generated data point (at large volumes of data points), which can be used as a reinforcement signal to the generator model.

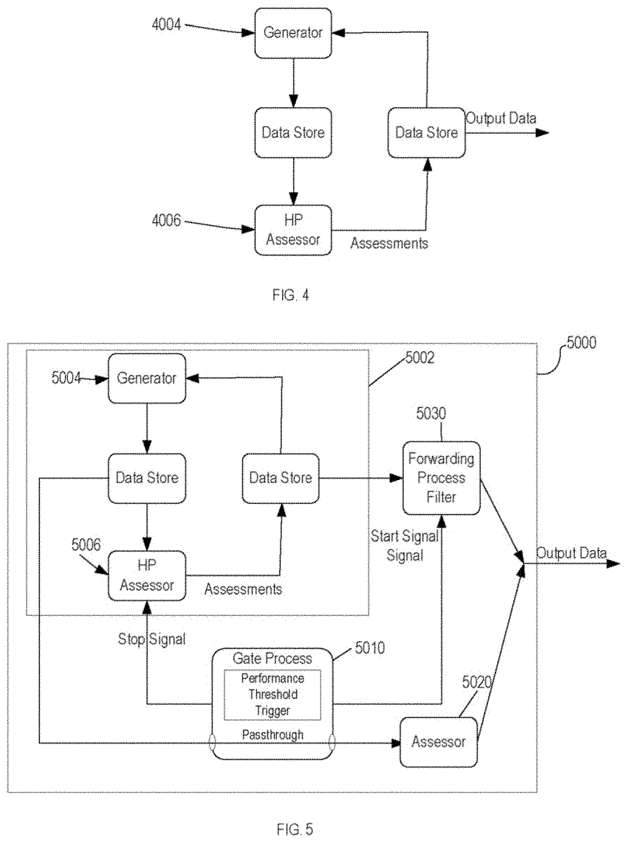

For example, FIG. 4 illustrates one example of guided data synthesis using generator/assessor feedback that includes a generator 4004 implementing a reinforcement learning algorithm. Generator 4004 generates synthetic data, which an HP assessor 4006 assesses. HP assessor 4006 returns assessment of the generated data to generator 4004. Acceptable data points can be used as output data.

Complex and hierarchical generator processes may include intermediate assessor processes.

For example, a workflow can be defined that specifies an iterative generator and assessor loop to implement reinforcement learning with a human-generated reinforcement signal, followed by a generator workflow that wraps two parallel generator workflows. A first parallel generator workflow comprises a workflow that uses reinforcement learning models that have reached a threshold level of performance and an assessor process that is used as a filter to determine whether data points generated by those trained reinforcement learning models are desirable. A first parallel generator workflow comprises a workflow that forwards previously generated data points that have already been assessed as desirable.

FIG. 5, for example, is a diagrammatic representation of a workflow 5000 for a more complex generator. Workflow 5000 has a first generator workflow 5002 that is similar to FIG. 4, a gate process 5010, a second assessor 5020, which may be an HP or MP assessor, and a filter process 5030. Workflow 5000 may also include additional data stores in the flow between the various processes (not shown for simplicity). Workflow 5002 includes a generator 5004 implementing a reinforcement learning algorithm. Generator 5004 generates synthetic data, which an HP assessor 5006 assesses. HP assessor 5006 returns assessment of the generated data to generator 5004.

Gate process 5010 monitors the data store that contains the assessments and once a sufficient threshold has been passed (assessments become “good enough” based on criteria specified for the specific instance) generates a first trigger signal to intermediate assessor 5006 and a second trigger signal to filter process 5030. According to one embodiment, the first trigger signal causes assessor 5006 to stop pulling records for assessment. In another embodiment, the first trigger signal causes intermediate assessor 5006 to reduce the rate at which it pulls records for assessment, thus maintaining continual monitoring by assessor 5006 of data points generated by generator 5004 and reinforcement-based learning, albeit at a reduced rate.

The second trigger signal causes filter process 5030 to pull already assessed records from the output data store to provide as output from a larger-scoped complex generator. As new data points are generated by generator 5004, gate process 5010 pulls newly generated records from the data store of unassessed records for assessment by second assessor 5020. Second assessor 5020 determines whether the data points generated by those trained reinforcement learning models are desirable output from the larger-scoped complex generator and outputs the records that pass criteria configured for assessor 5020.

As will be appreciated, it may be desirable to train an ML model with data that represents variances so that the ML model learns to ignore the variances. For example, it may be desirable to train an ML model to recognize that a picture of a dog is still a picture of a dog even if it is rotated, cropped, color-shifted, or visually “noisy”. Workflows can be configured to implement domain specific transforms to preserve invariances that are meaningful to the target ML model while adding variances that the model should learn to ignore. Platform 1002 can support generators configured to apply a variety of transforms. The transforms can be either “rule based” (common for image processing) or learned (e.g., day-to night-images). In some embodiments, generative adversarial networks (GANs) can be used to learn transformations.

Combining human and machine stages in complex workflows allows the creation of custom (application specific) generators using dynamically defined, human-guided transforms. According to one embodiment, the goal for this type of generator is as follows: given a set of labeled data, generate a larger set of labeled data that preserves invariances that are relevant to the target application (e.g., training a ML model to produce a given inference) while expanding the quantity and diversity/variation of data relevant to that application.

The premise for this type of generator is that some existing data points exhibit variations that could be inserted/reflected in known ways across many other data points. The type of variation and the way in which it is injected into new data points are defined together as a type of transform.

As an example: a transform can be configured to take a selected subsection or subsections of a given image (the variation) and superimpose that selection on multiple other images within the region(s) selected as valid within those target images (the injection). Many options exist for injection mechanisms in this type of transform, including the following. In one example, valid target regions can include the entire image (by default) or some specified region (e.g., sky, or body of water). Alternately, injection points could be explicitly identified by key points in the target images. In another example, using standard image processing transformations, variations can be scaled, rotated, or stretched/distorted to fit the identified valid regions, or could be keyholed inside selected areas of the target images.

As another example, a transform can be configured to apply a text transform to identify regional or cultural idiom phrases (as a variation) from a given text document and insert that idiom into multiple other text documents in contextually appropriate places, either appending to or replacing parts of existing text.

The programmatic implementation of each type of transform is specified by the definition of workflow stages (e.g., how a variation is superimposed on an image), but the specific variations (e.g., selected subsection or subsections, regional or cultural idiom phrases) are selected by human or machine activities in the workflow stages and the identification of how they map to other data points is highly customized to both the application and to individual data points as they move through these workflows. For example, the same customizable image transform generator workflow could be used to i) copy and scale a window reflection (variation) into designated points in a large set of other images (e.g., to generate images that include window reflections) and ii) copy and scale an occluding object (variation) into designated points in a large set of other images (e.g., to generate images that include the occluding object). In another example, the same customizable image transform generator workflow could be used to i) scale and shape customized color and texture overlays (variations) to fit the area(s) selected in a large set of other images (e.g., to generate images with color and/or texture variation) and ii) scale and shape images of netting or tarps to fit areas selected in a large set of images (e.g., to generate images of crops to which a covering has been added).

In this way, the transform implemented by a workflow is customized to each variation that can be identified within available data points and is also custom fit to each data point that it is applied to using a combination of human and machine activities.

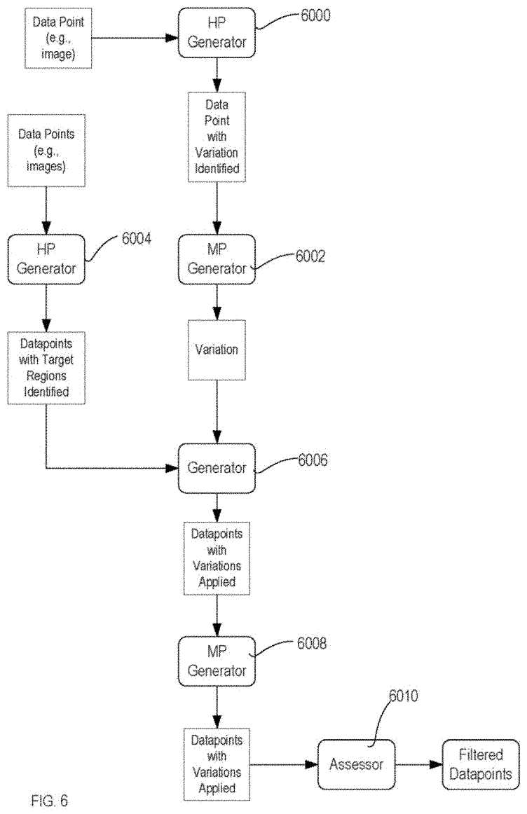

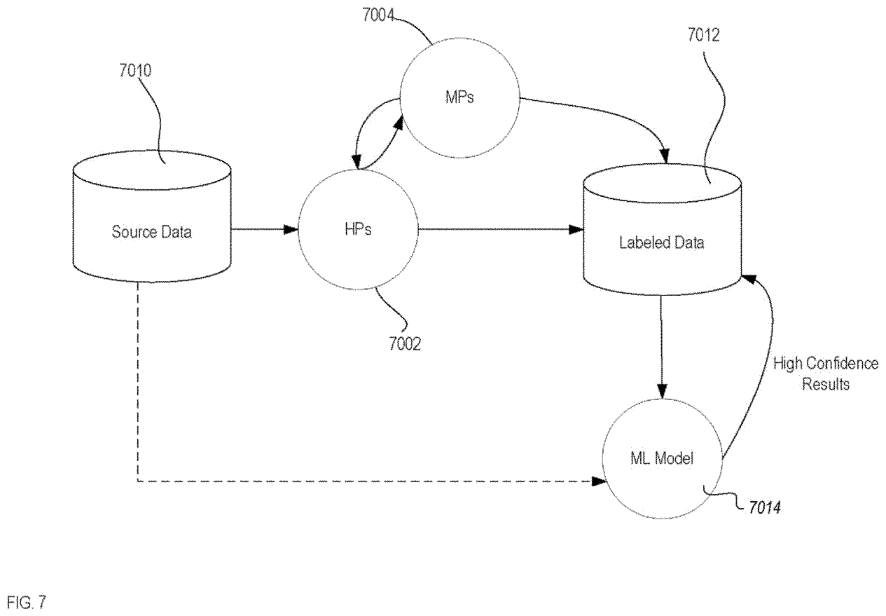

For example, workflow stages for such a generator could be configured as illustrated in FIG. 6 (process data stores not illustrated separately).

In this example, an HP 6000 identifies a specified element or feature of a provided data point as the variation. As one example, a human user may be provided an interface and instructed to draw a polygon around a light reflection in a car or building window or around a particular type of object that occludes other objects. As another example, a human user may be provided an interface and instructed to bound a snippet of text based on characteristics provided in a set of human-interpretable instructions. As another example, a human user may be provided an interface and instructed to bound a snippet of audio based on characteristics provided in a set of human-interpretable instructions.

In this example, an MP 6002 extracts the identified variation from the original data point.

An HP 6004 identifies valid target regions or points for inserting the variation into each available data point. As one example, a human user may be provided an interface and instructed to put polygons around all the windows where a light reflection could exist or identify regions (such as a street) where an occluding object (such as a car) could be placed. As another example, a human may be provided an interface and instructed to identify sections of text that could be replaced by the snippet without breaking grammar rules. As another example, a human may be provided an interface and instructed to identify sections of audio that could be replaced by the snippet without breaking grammar rules.

A process 6006 applies the variation to the data points. As one example, a human user may use a “stamp” type image tooling interface to directly apply the variation to a new image and transform it to fit (scale, rotate, stretch, etc.) the target image context. As another example, an MP may superimpose the variation on new images using the valid target regions (placing randomly within the target regions) or insertion key points defined by the previous stages. As additional examples, an HP or MP may be used to insert a snippet of text into multiple document or a snippet of audio into multiple audio files and target regions.

An MP 6008 may perform additional transformations. For example, an MP may be used to smooth out, normalize, or otherwise blend the variation into the new datapoint such that the variation does not present as an anomaly within the new datapoint (e.g., different background noise or volume in audio clips, significantly different pixel-value distributions within the variation and the rest of the image, etc.)

At the end of this type of generator workflow, an assessor process 6010 can be used to filter the data points generated with the custom variations to ensure they are valid data points in the context of the application for which they will be used (e.g., do the images still look like realistic photographs?).

Each of the basic generators and assessors of FIGS. 4-6 may be independently configurable and executable code components present in platform 1002. Based on a configuration for the given workflow, the directed graph service 1005 configures and executes each generator and assessor as needed.

The preceding examples are illustrative only and should not be taken to limit the types of transforms that the platform 1002 can provide. Although the transforms are depicted as statically defined (per workflow) in this description, the platform 1002, in some embodiments, supports both manually updating and replacing transform stages within a workflow to achieve improved generation and also any dynamic (automated) updates to transforms that may be wrapped within the workflow (e.g., using an ML model that is trained online, while the workflow is running, to identify valid image regions to insert a variation using a prescribed or learned set of target characteristics for such regions).

In some embodiments, guided synthesis using customized data transforms with anomaly detection, may be used. The customizable-transform generator workflow described above can be augmented with a workflow stage or stages that identify data points that contain variations of interest. For example, an HP can select images that contain windows with reflections. In another example, an MP can identify data points that represent outliers or anomalies along various dimensions in the features of the data. In another example, an HP or MP can report exceptions for particular data points that fall outside the ability of the process to complete the requested task (e.g., classification, prediction, localization) with a high enough confidence (e.g., an ambiguous image), and these can be examined by subsequent stages for identifying potential variations that could be replicated in other data points.

In some embodiments, guided synthesis using customized data sampling, may be used.

Combining human and machine stages in complex workflows also allows the creation of custom (application specific) generators using dynamically defined, human-guided data distribution sampling and resampling. Conceptually, sampling approaches build a mathematical model of how existing data is distributed (for example, a Normal Gaussian distribution in one dimension) and then use that model to generate new data to fit that distribution. Resampling approaches can create “balanced” samples (uniformly representing all possible areas of a distribution) that draw more samples from the “tails” (less populated areas) of a distribution, or less samples from the “center” (more populated areas) of a distribution in order to achieve an even representation of data points from all parts of a distribution. Typically, data points are represented in more than one dimension, and many practical data applications (e.g., using images or text) are referred to as “high dimensional” feature spaces. Sampling valid data points from a high dimensional distribution is mathematically challenging because higher dimensionality results in mostly “empty space” compared to the same amount of known data points in low dimensional space (textbooks refer to this problem as the “curse of dimensionality”). Sampling randomly from high-dimensional probability distributions typically results in data points with invalid combinations of the feature values that cannot exist in practice. Various approaches to drawing valid samples from high-dimensionality features spaces have been developed including Generative Adversarial Networks, where a machine learning model is trained to generate samples, and a discriminator (or adversary) machine learning model is trained to distinguish between valid (or “real”) and invalid (generated) data points. Such approaches require a very large amount of initial labeled data (e.g., billions of images of faces) to sufficiently populate the high-dimensional feature space such that areas of the space from which to draw valid sample data points can be drawn.

If the amount of available data is small compared to the ability to populate a high-dimensional data space, generating data through techniques that rely on modeling the high-dimensional distribution will result in a high percentage of invalid data points. Historically, content-preserving transformations have been used to increase data diversity with data points known to be valid. For example, if an ML model is being trained on a computer vision task where the relevant task is identifying whether an image contains faces, there are well-understood and universally applicable image transformations that include rotating, inverting images or adding visual noise that may appear as “static”, blur, or color transformations. Such variation does not change the content's validity as an image. However, random samples from the image space may produce faces that are not valid. Application-specific constraints exist that cannot be universally encoded for all images. For example, in a “faces” application, invariances that should be preserved may include the relative positions of facial features with respect to one another or a constraint such as “no more than two eyes per person”. In the described platform, assessor processes that rely on human judgements to assess human-interpretable constraints on valid data points (which cannot, for example, be reproduced accurately in an automated learned discriminator model) can be used to provide improved feedback or specification of feature distribution areas that contain valid data points such that generator processes can restrict sampling and resampling to the regions identified by human guidance through assessor processes.

Multiple MPs and HPs can be composed together into directed graphs as needed to generate synthetic data. The overall graph can be thought of abstractly as a single generator, and each generator and assessor in the graph may itself be implemented as a directed graph. There may be branches, merges, conditional logic, and loops in a directed graph. In some cases, a configuration can define a processing graph in which the output provided by a process is looped back for reinforcement learning at a node. Each directed graph may include a fan-in to a single output or exception per input element.

Directed graph service 1005 creates directed graphs workflows including directed graphs of components to compose complex processes. Directed graph service 1005 determines the directed graph of components and their order of execution to create workflows according the configuration. It can be noted that some processes can include other processes. Thus, a particular process may itself be a graph inside another process graph.

Configuration service 1003 passes directed graph service 1005 the configurations for a workflow, including the individual MPs, HPs, process data stores and data flows for the workflow so that directed graph service 1005 can compose the various components into the specified workflow.

Dispatcher service 1009 is responsible for interacting with human specialists (see FIG. 3). Dispatcher service 1009 routes tasks and task interfaces to human specialists and receives the human specialist output (assessments, generated data). Configuration service 1003 provides configuration information for HPs to dispatcher service 1009, such as user selection criteria and UI configuration. When a task is distributed to a human specialist, the platform can stop processing at a node of the graph to wait for a response from the human specialist and then continue processing based on the response.

Platform 1002 may include other services, not shown, such as an input service via which original data 1028 can be provided to platform 1002 and an output service via which labeled generated data 1038 can be provided to end-users.

As discussed above, platform 1002 may provide guided synthesis that may be used to train one or more ML models. FIG. 7 illustrates an example flow. A workflow is defined for platform 1002 that includes HPs 7002 to provide guidance for synthesis (e.g., HPs for human users to identify a variance in an image and target regions in input images in which to insert the variance) and an MPs 7004 to augment input data to generate synthetic data. An MP 7010 includes an ML trained to label or classify images.

An end user provides a set of labeled source images 7010 and initiates the workflow to process the source images 7010. As discussed above in conjunction with FIG. 7, the HPs 7002 can identify a variance in a source image and regions of other source images in which to insert the variance. The MPs 7004 extract the variance from the first source image, insert the variance into the other source image and perform other transforms to generate synthetic data points (e.g., labeled augmented images). The labeled source images and labeled augmented images are stored as a labeled data 7012. MP 7014 assesses the labeled augmented images. The images that MP 7014 can classify with a threshold level of confidence and the labeled source data are output as labeled data 7012 that can be used to train a target ML model. In some cases, MP 7014 also evaluates the source images.

Although the invention has been described with respect to specific embodiments thereof, these embodiments are merely illustrative, and not restrictive of the invention. The description herein (including the Appendices) is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Those skilled in the relevant art will appreciate that embodiments can be implemented or practiced in a variety of computer system configurations including, without limitation, multi-processor systems, network devices, mini-computers, mainframe computers, data processors, and the like. Embodiments can be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, stored as firmware in chips, as well as distributed electronically over the Internet or over other networks (including wireless networks). Example chips may include Electrically Erasable Programmable Read-Only Memory (EEPROM) chips.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention. Steps, operations, methods, routines or portions thereof described herein be implemented using a variety of hardware, such as CPUs, application specific integrated circuits, programmable logic devices, field programmable gate arrays, optical, chemical, biological, quantum or nanoengineered systems, or other mechanisms.

Software instructions in the form of computer-readable program code may be stored, in whole or in part, temporarily or permanently, on a non-transitory computer readable medium. The computer-readable program code can be operated on by a processor to perform steps, operations, methods, routines or portions thereof described herein. A “computer-readable medium” is a medium capable of storing data in a format readable by a computer and can include any type of data storage medium that can be read by a processor. Examples of non-transitory computer-readable media can include, but are not limited to, volatile and non-volatile computer memories, such as RAM, ROM, hard drives, solid state drives, data cartridges, magnetic tapes, floppy diskettes, flash memory drives, optical data storage devices, compact-disc read-only memories. In some embodiments, computer-readable instructions or data may reside in a data array, such as a direct attach array or other array. The computer-readable instructions may be executable by a processor to implement embodiments of the technology or portions thereof.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any suitable programming language can be used to implement the routines, methods or programs of embodiments of the invention described herein, including R, Python, C, C++, Java, JavaScript, HTML, or any other programming or scripting code, etc. Communications between computers implementing embodiments can be accomplished using any electronic, optical, radio frequency signals, or other suitable methods and tools of communication in compliance with known network protocols. Any particular routine can execute on a single computer processing device or multiple computer processing devices, a single computer processor or multiple computer processors. Data may be stored in a single storage medium or distributed through multiple storage mediums. In some embodiments, data may be stored in multiple database, multiple filesystems or a combination thereof.

Although the steps, operations, or computations may be presented in a specific order, this order may be changed in different embodiments. In some embodiments, some steps may be omitted. Further, in some embodiments, additional or alternative steps may be performed. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Although the foregoing specification describes specific embodiments, numerous changes in the details of the embodiments disclosed herein and additional embodiments will be apparent to, and may be made by, persons of ordinary skill in the art having reference to this disclosure. In this context, the specification and figures are to be regarded in an illustrative rather than a restrictive sense, and all such modifications are intended to be included within the scope of this disclosure.

What is claimed is:

1. A computer-implemented method for guided synthesis of data, comprising:
receiving a set of input data from a data store;
transforming the set of input data, by one or more generators, to generate a set of output data;
storing the generated set of output data;
producing an assessment, by one or more assessors, of the set of output data against a set of characteristics to determine whether the set of characteristics are met by the set of output data, wherein the one or more generators and one or more assessors are used in a configurable series, parallel, or hierarchical workflow; and
storing the generated set of synthetic data in a second data store.

2. The computer-implemented method of claim 1, wherein one or more of the generators comprises a machine learning generator.

3. The computer-implemented method of claim 1, wherein one or more of the generators comprises a human process, wherein the human process comprises computer code configured to perform operations and support interactions with a human specialist.

4. The computer-implemented method of claim 1, wherein the assessment is produced by a machine learning assessor.

5. The computer-implemented method of claim 1, wherein the assessment is produced using a human process, wherein the human process comprises computer code configured to perform operations and support interactions with a human specialist.

6. The computer-implemented method of claim 1, wherein the set of computer-executable instructions further comprises instructions for:
specifying a combination of stages of a workflow, the stages of the workflow including a generator stage and an assessor stage;
configuring inputs and outputs of the stages of the workflow; and
configuring connections between the stages of the workflow.

7. The computer-implemented method of claim 6, wherein the specified stages of a workflow include a combination of machine learning processes and human processes.

8. The computer-implemented method of claim 1, wherein the set of computer-executable instructions further comprises instructions for augmenting the set of output data based on the assessment to generate a set of synthetic data.

9. The computer-implemented method of claim 1, wherein the set of computer-executable instructions further comprises instructions for:
packaging, by a dispatcher service, a generated set of data as a task for presentation to a human specialist using a task user interface template; and
receiving a task result, by the dispatcher service, from the human specialist and returning the task result to the human process.

10. The computer-implemented method of claim 9, further comprising validating, by the dispatcher service, the task result.

11. The computer-implemented method of claim 9, further comprising:
providing defined groups of human specialists; and
specifying one of the defined groups of human specialists in the task.

12. The computer-implemented method of claim 1, further comprising:
monitoring, by a gate process, stored sets of generated synthetic data in the second data store; and
responsive to determining that a threshold has been reached regarding the generated set of synthetic data, generating a trigger signal for stopping the assessment of output data.

13. The computer-implemented method of claim 12, further comprising responsive to determining that a threshold has been reached regarding the generated set of synthetic data, generating a second trigger signal for causing a filter process to provide available synthetic data from the second data store.

14. A computer program product comprising a non-transitory, computer-readable medium storing thereon a set of computer-executable instructions, the set of computer-executable instructions comprising instructions for:
receiving a set of input data from a data store;
transforming the set of input data, by one or more generators, to generate a set of output data;
storing the generated set of output data;
producing an assessment, by one or more assessors, of the set of output data against a set of characteristics to determine whether the set of characteristics are met by the set of output data, wherein the one or more generators and one or more assessors are used in a configurable series, parallel, or hierarchical workflow; and
storing the generated set of synthetic data in a second data store.

15. The computer program product of claim 14, wherein the one or more generators and the one or more assessors are comprised of a combination of processes including machine learning processes and human processes, wherein the human processes comprise computer code configured to perform operations and support interactions with a human.

16. The computer program product of claim 14, wherein the set of computer-executable instructions further comprises instructions for:
specifying a combination of stages of a workflow, the stages of the workflow including a generator stage and an assessor stage;
configuring inputs and outputs of the stages of the workflow; and
configuring connections between the stages of the workflow.

17. The computer program product of claim 16, wherein the specified stages of a workflow include a combination of machine learning processes and human processes.

18. The computer program product of claim 1, wherein the set of computer-executable instructions further comprises instructions for augmenting the set of output data based on the assessment to generate a set of synthetic data.

19. The computer program product of claim 14, wherein the set of computer-executable instructions further comprises instructions for:
packaging, by a dispatcher service, the generated set of output data as a task for presentation to a human specialist using a task user interface template; and
receiving a task result, by the dispatcher service, from the human specialist and returning the task result to the human process.

20. The computer program product of claim 19, wherein the set of computer-executable instructions further comprises validating, by the dispatcher service, the task result.
